(19) United States
(12) Patent Application Publication
(10) Pub. No.: US 2009/0053583 A1
(43) Pub. Date: Feb. 26, 2009

(54) GAS DIFFUSION ELECTRODE AND PROCESS FOR PRODUCING IT AND ITS USE

(75) Inventors: Matthias Binder, Hasselroth-Neuenhasslau (DE); Joachim Koehler, Gruendau/Haingruendau (DE); Sandra Wittpahl, Herzogenaurach (DE); Claus-Rupert Hohenthanner, Hanau (DE); Michael Lennartz, Frankfurt (DE)

Correspondence Address: KALOW & SPRINGUT LLP, 488 MADISON AVENUE, 19TH FLOOR, NEW YORK, NY, 10022, US

(73) Assignee: UMICORE AG & CO KG, Hanau-Wolfgang (DE)

(21) Appl. No.: 11/813,336

(22) PCT Filed: Jan. 11, 2006
(86) PCT No.: PCT/EP2006/000157

§ 371 Date: Dec. 3, 2007

(30) Foreign Application Priority Data
Jan. 14, 2005 (EP) 05000660.0

(51) Int. Cl. H01M 4/96; G01N 27/403; B23H 3/04; B32B 38/10

(52) U.S. Cl. 429/44; 204/400; 204/290.01; 156/230

(57) ABSTRACT

The invention describes a process for producing a gas diffusion electrode which has a catalyst layer having a smooth surface, wherein the smooth surface of the catalyst layer is produced by bringing the catalyst layer in the moist state into contact with a transfer film and removing this transfer film after drying. In variant A, the catalyst layer is firstly produced on a transfer film and then transferred in the moist state to the gas diffusion layer. In variant B, the catalyst layer is applied to the gas diffusion layer, and a transfer film is then placed on top. In both cases, the structure produced in this way is subsequently dried. Before further processing, the transfer film is removed to give a gas diffusion electrode having a smooth catalyst surface which has a maximum profile peak height (Rp) of less than 25 microns. The electrodes are used for producing membrane-electrode assemblies for membrane fuel cells or other electrochemical devices. Membrane-electrode assemblies comprising the gas diffusion electrodes of the invention display very good long-term behaviour.

The invention relates to the field of electrochemistry and describes a gas diffusion electrode (GDE) having a smooth surface and a process for producing it and its use. These electrodes are used for producing membrane-electrode assemblies (MEAs) for electrochemical devices such as fuel cells, membrane fuel cells (PEMs, DMFCs), electrolysers or sensors.

Fuel cells convert a fuel and an oxidant at separate locations at two electrodes into electric power, heat and water. Hydrogen, a hydrogen-rich gas or methanol can serve as fuel, and oxygen or air can serve as oxidant. The process of energy conversion in the fuel cell has a particularly high efficiency. For this reason, fuel cells are becoming increasingly important for mobile, stationary and portable applications. Membrane fuel cells (PEMFCs, DMFCs, etc.) are particularly suitable for use in the above mentioned fields because of their compact construction, their power density and their high efficiency.

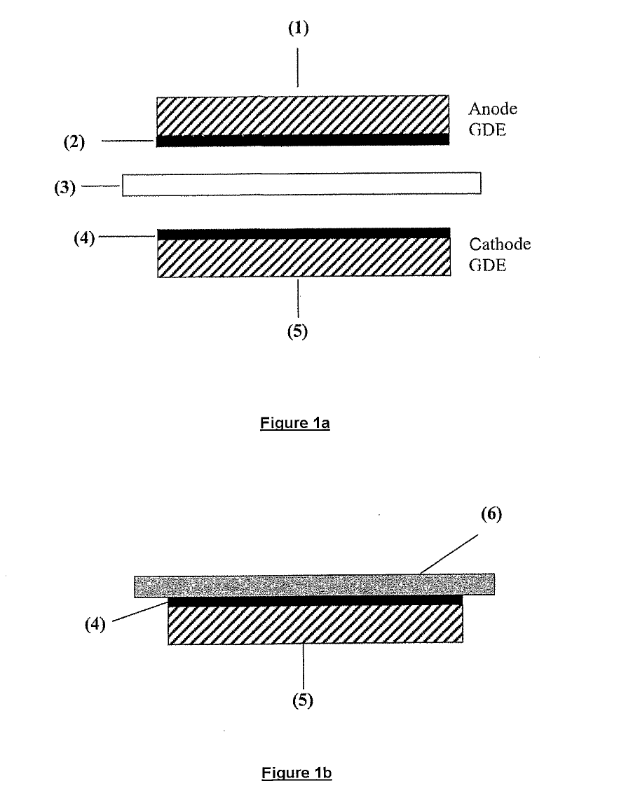

The key component of a PEM fuel cell is the membrane-electrode assembly (MEA). The membrane-electrode assembly has a sandwich-like structure and generally comprises five layers: (1) anode gas diffusion layer, (2) anode catalyst layer, (3) ionomer membrane, (4) cathode catalyst layer and (5) cathode gas diffusion layer. Here, the anode gas diffusion layer (1) together with the anode catalyst layer (2) forms the gas diffusion electrode (GDE) on the anode side; the cathode gas diffusion layer (5) together with the cathode catalyst layer (4) forms the gas diffusion electrode (GDE) on the cathode side. A schematic structure of a 5-layer membrane-electrode assembly is shown in FIG. 1a.

In the production of a five-layer MEA, it is usual to position two catalyst-coated gas diffusion layers (or gas diffusion electrodes, GDEs) to the front and rear sides of an ionomer membrane (3) and press them together to form an MEA. However, other processes for producing MEAs, for example using catalyst-coated ionomer membranes (catalyst-coated membranes, CCMs), are also possible.

The present patent application relates to the production of catalyst-coated gas diffusion layers; such layers will hereinafter, as indicated above, be referred to as gas diffusion electrodes (GDEs). The GDEs of the invention are used in the production of membrane-electrode assemblies (MEAs) for electro-chemical devices, in particular for membrane fuel cells.

Gas diffusion electrodes (GDEs) are generally produced by coating gas diffusion layers with catalyst inks. The gas diffusion layers can comprise porous, electrically conductive carbon-containing materials such as carbon fibre paper, carbon fibre nonwoven, woven carbon fibre fabrics, fibre gauzes and the like and are usually hydrophobicized by means of fluorine-containing polymers (PTFE, polytetrafluoroethylene, etc.). They thus make it possible for the reaction gases to gain ready access to the catalyst layers and for the cell current and the water formed to be transported away readily. Furthermore, the gas diffusion layers can have a compensating layer (“microlayer”) which generally comprises conductive carbon black and fluorine-containing polymers on their surface.

The catalyst layers for anode and cathode comprise electrocatalysts which catalyze the respective reaction (oxidation of hydrogen or reduction of oxygen). As catalytically active components, preference is given to using the metals of the platinum group of the Periodic Table of the Elements (Pt, Pd, Ag, Au, Ru, Rh, Os, Ir). In most cases, use is made of supported catalysts (e.g. 40% by weight Pt/C) in which the catalytically active platinum group metals were applied in finely divided form to the surface of a conductive support material, for example carbon black. The catalyst layers can additionally contain proton-conducting polymers and/or ionomers.

In general, the gas diffusion electrodes are bonded to the polymer electrolyte membrane by means of lamination processes, i.e. physically with the aid of elevated pressure and elevated temperature. For this purpose, the electrodes and the polymer electrolyte membrane are pressed or laminated together either continuously or discontinuously, for example in a hot pressing process (cf., for example, EP 1 198 021).

The polymer electrolyte membrane (also referred to as “ionomer membrane”) usually comprises proton-conducting polymer materials. Preference is given to using a tetrafluoroethylene-fluorovinyl ether copolymer having acid functions, in particular sulfonic acid groups. Such a material is, for example, marketed under the trade name Nafion® by E.I. DuPont. However, it is also possible to use other, in particular fluorine-free, ionomer materials such as sulphonated polyether ketones or aryl ketones or polybenzimidazoles. Such membranes typically have thicknesses of from 30 to 200 microns.

Thin membranes (i.e. membranes having thicknesses below 50 microns) can be damaged during lamination because of the strong thermal and mechanical stresses. A disadvantage of conventional GDEs is that they have a relatively rough, uneven catalyst surface. If GDEs having such rough catalyst surfaces are pressed together with the ionomer membrane, the above-described damage to the membrane can occur.

If the catalyst surface of the GDE has projecting points or relatively coarse particles, these can perforate the membrane during lamination and form pinholes in the membranes. These pinholes in turn result in hot spots in the MEA, cause short-circuits and can lead to premature failure of the entire PEM stack. The life of the fuel cell is significantly shortened as a result.

However, not only membrane perforations but also other membrane damage (e.g. unevenness, areas of thinning) can occur in this lamination process. Such damage, too, can lead to a significant degradation of the performance of the MEA in long-term operation.

Compare, V. Stanic and M. Hoberecht, “MEA failure mechanisms in PEM fuel cells operated on Hydrogen and Oxygen”, Abstracts Fuel Cell Seminar, San Antonio/Tex., November 2004, page 85 f.

Membrane damage due to projecting carbon fibres have been known for some time from the literature.

EP 1 365 464 A2 of the applicant describes a process for producing gas diffusion layers (GDLs) and gas diffusion electrodes (GDEs), in which a continuous rolling process is used to smooth the surface of the microlayer or the catalyst layer. This process leads to GDLs and GDEs which have a surface roughness (Rt; total height of the profile in accordance with DIN ISO 4287) of less than 100 microns.

US 2002/0197525 describes a process in which the gas diffusion layer is brought down to a particular thickness in a rolling process in order to make the substrate even before coating with catalyst.

WO 03/092095 discloses prepressed gas diffusion layers which comprise plain weave fibre cloth and are compressed by more than 25%. Such gas diffusion layers display a reduced risk of short-circuits.

However, the above mentioned processes, which all encompass a pressing or rolling step, have the disadvantage that the gas diffusion layers and GDEs can be damaged or changed as a result of the high pressing pressures. For example, at an inappropriate pressing pressure, the sensitive carbon fibre material can become brittle or cracks can be formed in it. Furthermore, depending on the pressing conditions, the microstructure (pore size, pore volume, hydro-phobic/hydrophilic properties) of the layer can be changed. It has also been found that the surface of the catalyst layers is only insufficiently smoothed by such pressing or rolling processes.

It is therefore an object of the present invention to provide gas diffusion electrodes (GDEs) which have a particularly smooth catalyst surface. Furthermore, a process for producing such gas diffusion electrodes without a pressing or rolling step in which the gas diffusion layer can be damaged is to be provided. The process should be simple to carry out, versatile and suitable for continuous manufacture.

The membrane-electrode assemblies produced using the GDEs of the invention should be particularly suitable for long-term operation of membrane fuel cells.

This object is achieved by provision of a process for producing gas diffusion electrodes as set forth in claim 1. Advantageous embodiments of the process are indicated in dependent claims 2 to 13.

The object is also achieved by provision of a novel gas diffusion electrode as set forth in claims 14 to 16 and by its use for producing membrane-electrode assemblies.

The present invention describes a process for producing a gas diffusion electrode comprising a carbon-containing gas diffusion layer and a catalyst layer having a smooth surface, wherein the smooth surface of the catalyst layer is produced by bringing the catalyst layer in the moist state into contact with a transfer film and removing this transfer film after drying.

In a first embodiment (variant A), the invention provides a process for producing a gas diffusion electrode, which comprises the steps:
a) coating of a transfer film with catalyst ink,
b) transfer of the moist catalyst layer together with transfer film to the surface of a gas diffusion layer,
c) drying of the structure,
d) removal of the transfer film from the catalyst layer.

In a second embodiment (variant B), the invention provides a process for producing a gas diffusion electrode, which comprises the steps:
a) coating of a gas diffusion layer with a catalyst ink,
b) application of a transfer film to the surface of the moist catalyst layer,
c) drying of the structure,
d) removal of the transfer film from the catalyst layer.

In both process variants, a gas diffusion electrode comprising a carbon-containing gas diffusion layer and a catalyst layer and having a transfer film applied to the surface of the catalyst layer is obtained in step c). After removal of the transfer film, the gas diffusion electrode of the invention has a catalyst layer having a smooth surface. The smooth surface has a maximum profile peak height “Rp” (measured in accordance with DIN ISO 4287) of less than 25 microns, preferably less than 22 microns. The removal of the transfer film from the catalyst layer can be carried out directly during the course of the process, but the transfer film can also be removed only before further processing of the gas diffusion electrode.

The published EP 1 365 464 of the applicant describes a continuous rolling process for making the surface of gas diffusion layers even, with these gas diffusion layers being able to be produced with or without a catalyst layer. To characterize the surface roughness, the total height of the profile (“surface roughness”, “Rt”) in accordance with DIN ISO 4287 is employed. This value is given by the equation:

Rt=Rp+Rv (1)

where the value “Rp” in this equation (cf. Art. 4.1 in DIN ISO 4287/1998) is the maximum profile peak height within the single measurement length l. Similarly, the value “Rv” is the maximum profile valley depth within the single measurement length l. The total height of the profile “Rt” is given by the sum of these two parameters in accordance with eq. (1).

In EP 1 365 464, the surface roughness “Rt” is used to characterize the nature of the surface of the gas diffusion layers, with a value of Rt<100 microns representing a low surface roughness and leading to a small degree of damage to the membrane in the MEA lamination process. The parameter “open cell voltage” (OCV) is employed as a measure of the damage to the membrane in the lamination process. A high OCV value (typically above 970 mV) is characteristic of MEAs which have been produced using the gas diffusion layers of EP 1 365 464.

In the course of further studies, it has been found that the open cell voltage (OCV) is not sufficient for describing the properties of MEAs. A more precise characterization of the nature of the surface of the GDLs and GDEs is necessary to characterize, in particular, the long-term properties and life of the MEA. It has been found that the long-term properties of MEAs can be improved further when, in addition to the low surface roughness (=total height of the profile “Rt”) of <100 microns, the value “Rp” (the “maximum profile peak height”, the height of the largest profile peak within the measurement length 1) is also particularly low and is in a range of less than 25 microns, preferably less than 22 microns.

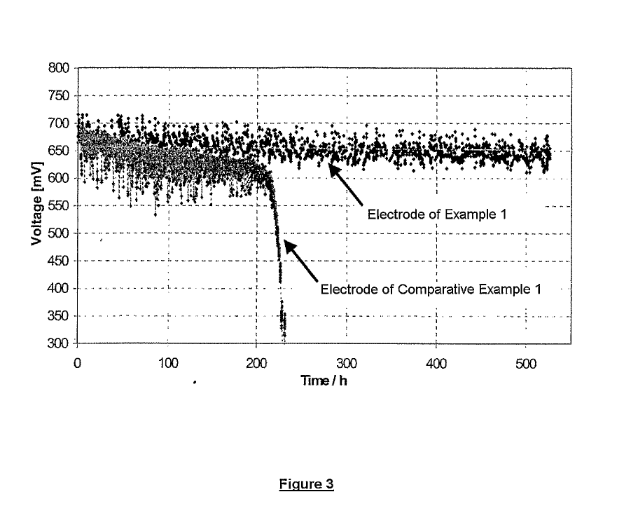

It has surprisingly been found that the total height of the profile (“Rt”) and the depth of the largest profile valley (maximum profile valley depth “Rv”) are of subordinate importance for the good long-term properties of the MEA. Thus, GDEs produced conventionally and according to the invention in both cases have Rt values and Rv values of <100 microns, but only the electrodes having Rp values below 25 microns give good long-term results for the membrane-electrode assemblies produced therewith (cf. FIG. 3).

The measurement of the parameters for characterizing the nature of the surface is carried out by means of a profile method in accordance with DIN ISO 4287. The process comprises a non-contact, white light distance measurement. In the distance measurement, the specimen is irradiated with focused white light from a xenon or halogen lamp by means of a sensor. If focused light impinges on a surface, this light is, in contrast to unfocused light, optimally reflected. Passive optics having a large chromatic aberration (wavelength-dependent index of refraction of lenses) break up the white light vertically into focus points of differing colour and thus height. The wavelength (colour) of the reflected light indicates, via a calibration table, the distance from the sensor to the specimen and thus gives the height information. The measurements described here were carried out using the “MicroProf®” instrument from FRT, Fries Research & Technology, D-51429 Bergisch-Gladbach. The measurement length “l” is 40 mm, and 20.000 measurement points per line are recorded.

The process for producing the inventive gas diffusion electrode having a particularly low maximum profile peak height (“Rp”) is described below.

It basically comprises a step in which a catalyst layer is brought into contact in the moist state with the smooth surface of a transfer film. The structure is subsequently dried and the transfer film is removed so as to produce a catalyst layer having a smooth surface. In this process, the catalyst layer is produced by means of an ink/paste. Two variants are possible here:

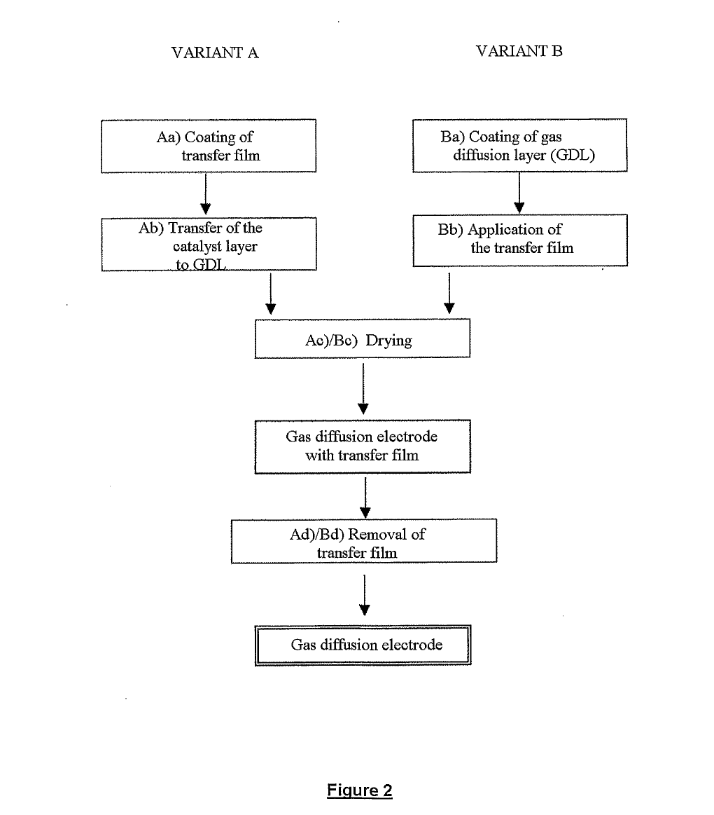

In variant A (cf. FIG. 2 and Example 1), the catalyst ink is firstly applied to a transfer film, and the moist catalyst layer which has been applied to the transfer film is transferred onto a gas diffusion layer (GDL). This can be effected by applying a gas diffusion layer to the moist layer or alternatively by turning the transfer film and placing it with the moist catalyst layer downward on the gas diffusion layer. In both cases, the composite structure formed as a result (transfer film/catalyst layer/gas diffusion layer) is dried. Before further use, the transfer film is removed to yield a GDE having a smooth catalyst surface. This process prevents the disadvantages of directly coating the GDL with catalyst ink (e.g. passage of the ink through the substrate or blocking of the pores). In addition, the amount of catalyst applied (catalyst loading in mg of Pt/cm²) is largely independent of the nature of the gas diffusion layer, which results in reduced fluctuations in the EM loading of the electrode.

In variant B (cf. FIG. 2 and Example 2), the catalyst ink is applied to the gas diffusion layer. A suitable transfer film is then laid on the moist catalyst layer. The composite structure (transfer film/catalyst layer/gas diffusion layer) is subsequently dried. After drying, the transfer film is removed to yield a GDE having a smooth catalyst surface. This variant has the advantage that direct coating of the transfer film is dispensed with.

The intermediate product produced in the process (i.e. the GDL/catalyst layer/transfer film structure, cf. FIG. 1b) can be stored as electrode precursor before or after drying. Since the catalyst layer is covered by the transfer film (6), it is protected against deposition of dust and other particles and from air. The transfer film can overlap the edges of the gas diffusion electrode and in this case simultaneously performs a protective and covering function, so that relatively long storage and transport of such electrode intermediate products can be carried out without problems. Before use of the gas diffusion electrode covered with film for producing MEAs, the transfer film or protective film (6) is removed.

The process of the invention can, in both the variants A and B, be carried out continuously, e.g. in a roll-to-roll process, and can be integrated with further processes, e.g. a subsequent lamination process, in a continuous line for the manufacture of membrane-electrode assemblies. The individual process steps are in this case carried out using strip-like materials; the equipment and measures necessary for this are known to those skilled in the art.

The application of the catalyst ink to the transfer film or to the gas diffusion layer can be carried out by means of conventional coating methods, for example screen printing, offset printing, stencil printing, spraying, brushing, doctor blade coating, roller coating, rolling, etc., either continuously or discontinuously. Appropriate methods are known to those skilled in the art.

The catalyst ink or paste is matched to the respective application method and can comprise organic solvents, for example glycols and alcohols, ionomers and additives; it can also be water-based. Suitable catalyst inks are described, for example, in EP 945 910 or EP 987 777.

As transfer films, use is made of thin substrates which have at least one surface having wetting behaviour and release behaviour matched to the catalyst ink or the catalyst layer. This surface should be very smooth and have a low maximum profile peak height Rp. Preference is given to using plastic films which display both good wetting of the surface on coating with catalyst ink and also good release behaviour, i.e. make it possible for the film to be easily detached after drying. Such films can be surface-treated, sealed or coated by means of specific techniques.

Particularly suitable films are siliconized poly-ethylene or polypropylene films, siliconized polyester films, release papers or special release films which are commercially available from various manufacturers (for example “LPDE-4P release Film 16.000”, Huhtamaki Deutschland GmbH, D-37077 Goettingen). Of course, it is also possible to use other film materials as long as they display good wetting and release behaviour in respect of the catalyst layer. The transfer films generally have a thickness of from 10 to 200 microns, preferably from 20 to 100 microns.

After coating of the transfer film (variant A), a gas diffusion layer with or without a microlayer is applied to the wet catalyst layer. This is effected under slight pressure, for example controlled via a roller or manually by smoothing. It is desirable for the full area of the substrate to be brought into contact with the moist catalyst layer. Depending on the type of GDL and the nature of its surface, this is effected virtually without pressure or under a slight pressure which should typically be less than 1 N/cm². A roller used for this purpose can be heated or unheated. A similar procedure is employed when the gas diffusion layer is firstly coated with catalyst ink (variant B) and the transfer film is applied to the moist catalyst layer.

In both variants, the composite structure (transfer film/catalyst layer/gas diffusion layer) is subsequently subjected to a drying process. Drying can be carried out by means of conventional methods, for example convection drying, hot air drying, IR drying, radiation drying, microwave drying or combinations thereof; it can be carried out in a continuous or batch process and is generally carried out at temperatures in the range from 50 to 150° C.

A gas diffusion electrode with transfer film is obtained as intermediate product. Before further processing of the GDE, the transfer film is removed and may be able to be used again. The gas diffusion electrodes produced in a simple manner by means of this process have a very smooth surface of the catalyst layer. Their maximum profile peak height (“Rp”) is less than 25 microns, preferably less than 22 microns. This gas diffusion electrode is used for producing membrane-electrode assemblies, for which purpose it is possible to use the conventional lamination and roller processes in a continuous or discontinuous form.

The following examples illustrate the invention.

### EXAMPLE 1

### Process with Coating of the Transfer Film

### Variant A

A gas diffusion layer (Sigracet 30BC, hydrophobicized, with microlayer, from SGL, Meitingen, Germany) is cut to size and weighed.

A transfer film (siliconized PE film, from Nordenia International AG, D-48577 Gronau) is cut to size (thickness: 50 microns, dimensions: 10×10 cm). A catalyst ink comprising supported Pt catalyst (40% by weight Pt/C, from Umicore, Hanau), Nafion® solution (10% by weight in water, from DuPont), organic solvent and water is printed by means of screen printing onto the coated side of the transfer film (print format: 7.1×7.1 cm, active area: 50 cm², catalyst loading: 0.2 mg of Pt/cm², use for the anode side).

The gas diffusion layer is placed centrally with the microlayer downwards on the moist catalyst layer. The substrate is then turned and the rear side of the transfer film is smoothed with a cotton cloth. Any air bubbles are removed in this way.

This composite structure (transfer film/catalyst layer/gas diffusion layer) is subsequently dried in a belt drier under hot air at a maximum of 95° C. for a few minutes.

A second gas diffusion electrode is then produced, with the catalyst loading being doubled (catalyst loading: 0.4 mg of Pt/cm²). This second gas diffusion electrode is used for the cathode side.

Before further processing (lamination with the ionomer membrane), the transfer film is removed and the catalyst surface is exposed. The catalyst surface of the GDE has the following surface properties (line measurement in accordance with DIN ISO 4287, measurement length: 40 mm, 20.000 measurement points/line, mean of 6 measurements, FRT-Microprof®)

| | |
|---|---|
| Maximum profile peak height Rp: | 21.5 microns |
| Maximum profile valley depth Rv: | 63.1 microns |
| Surface roughness Rt: | 84.6 microns |

A membrane-electrode assembly is produced from the resulting gas diffusion electrodes (anode GDE and cathode GDE) by pressing the anode GDE, the ionomer membrane (Nafion® NR 111, from DuPont, USA) and the cathode GDE at 150 N/cm² at 150° C. for 30 seconds in a hydraulic press. The electrochemical properties of the MEA produced in this way are subsequently measured in a single cell in a PEM fuel cell test apparatus.

The MEA displays very good long-term behaviour in hydrogen/air operation (cell temperature: 80° C., pressure: 1.5 bar, stoichiometry: 2/2). Thus, the cell voltage at a current density of 400 mA/cm² is constant at 650 mV after long-term operation for more than 500 hours (cf. FIG. 3).

### EXAMPLE 2

### Process with Coating of the Gas Diffusion Layer

### Variant B

A gas diffusion layer (Sigracet 30BC, hydrophobicized, with microlayer, from SGL, Meitingen, Germany) is cut to size and weighed.

A catalyst ink comprising supported Pt catalyst (40% by weight Pt/C, from Umicore, Hanau), Nafion® solution (10% by weight in water, from DuPont), organic solvent and water is printed by means of screen printing onto the gas diffusion layer (print format: 7.1×7.1 cm, active area: 50 cm², catalyst loading: 0.2 mg of Pt/cm², use for the anode side).

A transfer film (siliconized PE film, from Nordenia International AG, D-48577 Gronau) is cut to size (thickness: 50 microns, dimensions: 10×10 cm) and is placed with the treated side downwards on the moist catalyst layer. The rear side of the transfer film is then smoothed with a cotton cloth. Any air bubbles are removed in this way.

This composite structure is subsequently dried in a belt drier under hot air at a maximum of 95° C. for a few minutes. A second gas diffusion electrode is produced for the cathode, with the catalyst loading being doubled (catalyst loading: 0.4 mg of Pt/cm²). Before further processing (lamination with the ionomer membrane), the transfer film is removed and the catalyst surface is exposed.

The catalyst surface of the GDE has the following surface properties (line measurement in accordance with DIN ISO 4287, measurement length: 40 mm, 20.000 measurement points/line, mean of 6 measurements, FRT-Microprof®):

| | |
|---|---|
| Maximum profile peak height Rp: | 16.0 microns |
| Maximum profile valley depth Rv: | 34.3 microns |
| Surface roughness Rt: | 50.3 microns |

A membrane-electrode assembly is produced from the resulting gas diffusion electrodes (anode GDE and cathode GDE) as described in Example 1. The MEA displays very good long-term behaviour in continuous hydrogen/air operation (cell temperature: 80° C., pressure: 1.5 bar, stoichiometry: 2/2).

### COMPARATIVE EXAMPLE

### CE1

The Comparative Example describes the conventional coating process without smoothing of the catalyst layers.

Two gas diffusion layers (Sigracet 30BC, hydrophobicized, with microlayer, from SGL, Meitingen, Germany) are cut to size and weighed.

A catalyst ink comprising supported Pt catalyst (40% by weight Pt/C, from Umicore, Hanau), Nafion® solution (10% by weight in water, from DuPont), organic solvent and water is printed by means of screen printing onto the first gas diffusion layer (print format: 7.1×7.1 cm, active area: 50 cm², catalyst loading: 0.2 mg of Pt/cm², use for the anode side). A second gas diffusion layer is produced, with the catalyst loading being doubled (catalyst loading: 0.4 mg of Pt/cm², use for the cathode side).

The gas diffusion electrodes produced in this way are subsequently dried in a belt drier under hot air at a maximum of 95° C. for a few minutes. The catalyst surface of the GDE has the following surface properties (line measurement in accordance with DIN ISO 4287, measurement length: 40 mm, 20.000 measurement points/line, mean of 6 measurements, instrument: Micro-Prof®):

| | |
|---|---|
| Maximum profile peak height Rp: | 32.3 microns |
| Maximum profile valley depth Rv: | 57.7 microns |
| Surface roughness Rt: | 90.0 microns |

A membrane-electrode assembly is produced from the two gas diffusion electrodes (anode GDE and cathode GDE) as described in Example 1. This MEA displays poor long-term behaviour in continuous hydrogen/air operation (cell temperature: 80° C., pressure: 1.5 bar, stoichiometry: 2/2), cf. FIG. 3). Soon after commencement of operation, a noticeable reduction in the cell voltage occurs; after about 220 hours, the cell voltage drops to a value below 300 mV. This means that the MEA is not suitable for long-term operation.

1. Process for producing a gas diffusion electrode wherein the electrode comprises a carbon-containing gas diffusion layer and a catalyst layer having a smooth surface, the process comprising the steps of bringing the catalyst layer in a moist state into contact with a transfer film and removing said transfer film from the catalyst layer after drying so as to produce a smooth surface on the catalyst layer.

2. Process for producing a gas diffusion electrode according to claim 1, comprising the steps:
a) coating the transfer film with a catalyst ink to form a moist catalyst layer on the transfer film,
b) transferring the moist catalyst layer together with the transfer film to the gas diffusion layer to form a structure,
c) drying the structure, and
d) removing the transfer film from the catalyst layer.

3. Process for producing a gas diffusion electrode according to claim 1, comprising the steps:
a) coating the gas diffusion layer with a catalyst ink to form a moist catalyst layer on the gas diffusion layer,
b) applying the transfer film to the surface of the moist catalyst layer to form a structure,
c) drying the structure, and
d) removing the transfer film from the catalyst layer.

4. Process for producing a gas diffusion electrode according to claim 1, wherein the removal of the transfer film from the catalyst layer is effected before further processing of the gas diffusion electrode.

5. Process for producing a gas diffusion electrode according to claim 1, wherein the carbon-containing gas diffusion layer comprises carbon fibre nonwoven, woven carbon fibre fabric, carbon fibre paper, fibre gauzes or comparable substrates.

6. Process for producing a gas diffusion electrode according to claim 1, wherein the carbon-containing gas diffusion layer has been hydrophobicized and/or is provided with a microlayer.

7. Process for producing a gas diffusion electrode according to claim 1, wherein the catalyst layer comprises catalysts comprising precious metals, preferably Pt catalysts supported on carbon black.

8. Process for producing a gas diffusion electrode according to claim 1, wherein the catalyst layer is applied to the transfer film or to the gas diffusion layer by means of catalyst-containing inks applied by coating methods such as screen printing, offset printing, stencil printing, spraying, brushing, doctor blade coating, roller coating or rolling.

9. Process for producing a gas diffusion electrode according to claim 1, wherein a thin substrate which has at least one surface having good wetting behaviour and release behaviour in respect of the catalyst layer is used as the transfer film.

10. Process for producing a gas diffusion electrode according to claim 1, wherein a surface-treated film selected from the group consisting of siliconized polyethylene films, siliconized polyester films, siliconized polypropylene films, coated release papers and other decal films or protective films is used as the transfer film.

11. Process for producing a gas diffusion electrode according to claim 1, wherein the transfer film has a thickness in the range from 10 to 200 microns, preferably from 20 to 100 microns.

12. Process for producing a gas diffusion electrode according to claim 1, wherein the drying is carried out by means of convection, hot air, IR, radiation, microwave or combinations thereof, said drying being performed at temperatures in the range from 50 to 150° C.

13. Process for producing a gas diffusion electrode according to claim 1, wherein the process steps are carried out in a continuous process.

14. Gas diffusion electrode comprising a carbon-containing gas diffusion layer and a catalyst layer, wherein a transfer film has been applied to the surface of the catalyst layer.

15. Gas diffusion electrode according to claim 14, wherein the catalyst layer has a smooth surface having a maximum profile peak height (Rp, measured in accordance with DIN ISO 4287) of less than 25 microns, preferably less than 22 microns, after removal of the transfer film.

16. Gas diffusion electrode comprising a carbon-containing gas diffusion layer and a catalyst layer having a smooth surface, wherein the smooth surface has a maximum profile peak height (Rp, measured in accordance with DIN ISO 4287) of less than 25 microns, preferably less than 22 microns.

17. Process for producing membrane-electrode assemblies for membrane fuel cells, wherein at least one gas diffusion electrode comprising a carbon-containing gas diffusion layer and a catalyst layer having a smooth surface which has a maximum profile peak height (Rp, measured in accordance with DIN ISO 4287) of less than 25 microns, preferably less than 22 microns, is laminated with a polymer electrolyte membrane under pressure and at elevated temperature.

18. A membrane-electrode assembly for fuel cells, electrolysers, sensors or other electrochemical devices comprising the gas diffusion electrodes produced by the process according to claim 1.
